(19) United States
(12) Patent Application Publication
(10) Pub. No.: US 2017/0364654 A1
(43) Pub. Date: Dec. 21, 2017

(54) METHOD AND SYSTEM FOR FACILITATING PROVISIONING OF HEALTH DATA DURING EMERGENCIES

(71) Applicant: Jeffrey Joseph Schemansky, Shelby Charter Township, MI (US)

(72) Inventor: Jeffrey Joseph Schemansky, Shelby Charter Township, MI (US)

(21) Appl. No.: 15/624,023

(22) Filed: Jun. 15, 2017

Related U.S. Application Data
(60) Provisional application No. 62/350,481, filed on Jun. 15, 2016.

(51) Int. Cl. G06F 19/00; G06F 21/62

(52) U.S. Cl. CPC G06F 19/3418; G06F 19/322; G06F 21/6245

(57) ABSTRACT

Disclosed is a method for facilitating provisioning of health data during emergencies. The method includes receiving a health data associated with an individual from an individual device. Further, the method includes storing the health data in association with an identifier associated with the individual. Yet further, the method includes receiving an indication of a medical emergency associated with the individual. Further, the method includes retrieving the health data associated with the individual based on receipt of the indication of the medical emergency. Further, the method includes receiving a location of the individual from a mobile device, wherein the mobile device is configured to detect the location. Moreover, the method includes identifying at least one professional device based on the location. Further, the method includes transmitting the health data to the at least one professional device.

The current application claims a priority to the U.S. Provisional Patent application Ser. No. 62/350,481 filed on Jun. 15, 2016

### FIELD OF THE INVENTION

The present invention relates to medical emergencies. In particular, the present invention relates to a method and a system for facilitating provisioning of health data during emergencies.

### BACKGROUND OF THE INVENTION

Medical emergencies may be related to an automobile accident, an indoor accident and a chronic health condition. The first responders are trained to help people in medical emergencies. Often, people involved in medical emergencies are incapable of communicating with the first responders.

Further, when responding to emergency situations, the first responders are provided with minimal information regarding the specific incident and affected persons. This may lead to considerable delay in a proper response. Further, sometimes there are delays in transmitting health information to the first responders.

Therefore, there is a need for improved methods and systems to quickly provide relevant and accurate patient information to the first responders.

### SUMMARY OF THE INVENTION

This summary is provided to introduce a selection of concepts in a simplified form that are further described below in the Detailed Description. This summary is not intended to identify key features or essential features of the claimed subject matter. Nor is this summary intended to be used to limit the claimed subject matter's scope.

Disclosed is a method of facilitating provisioning of health data during emergencies. The method includes receiving, using a communication device, a health data associated with an individual from an individual device. Further, the method includes storing, using a storage device, the health data in association with an identifier associated with the individual. Yet further, the method includes receiving, using the communication device, an indication of a medical emergency associated with the individual. Further, the method includes retrieving, using the storage device, the health data associated with the individual based on receipt of the indication of the medical emergency. Further, the method includes receiving, using the communication device, a location of the individual from a mobile device, wherein the mobile device is configured to detect the location. Moreover, the method includes identifying, using the processing device, at least one professional device based on the location. Further, the method includes transmitting, using the communication device, the health data to the at least one professional device.

According to some aspects, a system for facilitating provisioning of health data during emergencies is disclosed. The system includes a communication device configured for receiving a health data associated with an individual from an individual device, receiving an indication of a medical emergency associated with the individual, receiving a location of the individual from a mobile device, wherein the mobile device is configured to detect the location and transmitting the health data to at least one professional device. Further, the system includes a storage device configured for storing the health data in association with an identifier associated with the individual and retrieving the health data associated with the individual based on receipt of the indication of the medical emergency. Yet further, the system includes a processing device configured for identifying the at least one professional device based on the location.

According to some aspects, the emergency medical form may include important questions in the event of an emergency. The form may allow individuals to provide additional information on the form. The form may also upload a photograph of the individual. The form may attach photographs that the individual feels is necessary or relevant, along with other documents, advanced directives, and additional paperwork. For example, the emergency medical form may include one or more information of last updated, photo, name, address, D.O.B., phone #, license plate #, height, weight, hair color, eye color, primary language, medical history, medications, allergies, hearing or vision difficulties, advanced directives, preferred hospital, doctors name, health insurance, additional information, emergency contact: name, phone #, relationship, photograph uploads and attachments, and vitals. Filling out information in the forms, beyond the name, address, and date of birth, may be optional. Further, the form may be printed from the computer. The form may be updated or edited at any time. If individual creates form through a software application, the form may be accessed through website as well.

According to further aspects, medical or vital sign devices may be used to connect the individual's heart rate, SpO2, blood pressure, blood glucose, EKG, respiratory rate type devices to their emergency medical form. For example, if and when an individual is wearing a medical device, the vital signs may be taken and automatically updated to their form. A software application may allow individuals to view and monitor vital signs. Further, the software application may monitor the individual's vital signs and if there is detection of abnormalities, the software application may send out an alert to the individual, friends, family members and to the website of the facility. The dispatch and ambulance agencies may have the ability to receive an alert of a resident of the community if vitals sign abnormalities are detected.

According to some aspects, a software application may allow individuals to upload medical information and may provide verified medical personnel with access to pertinent medical information. Further, the software application may allow patients to have all of their personal and medical information in the hands of paramedics, or first responders (such as Emergency Medical Technicians (EMTs)), before they arrive on scene. The patient information may also be accessed on scene in the event it could not be accessed before the responder's arrival. The software application may require two sides for registration, one for individuals (patients) and one for first responders. Further, the application may be used by one or more of individuals, relatives, nursing homes, senior living communities, care facilities, independent living facilities, ambulance and police dispatchers, first responders and hospitals.

According to further aspects, an “EMF” website may be provided. The individuals may login on the website and fill out one or more forms (emergency medical forms). For example, family members may sign up loved ones such as parents or grandparents with the website. The software application may work in parallel with the website. Further, nursing homes, senior living or elderly communities, assisted livings, and care facilities may login to have access to the forms and they may also fill out forms for their residents. The care facility may fill out the form for an individual living at the facility. The facility may have the ability of logging in and have own page where they may open and access their resident's information or forms. Yet further, dispatch and ambulance companies may create a profile on the web site, such that they may be able to search and access the forms. The dispatch and ambulance companies may forward forms and information to first responders before they arrive on scene. Accordingly, when someone calls 911 or requests services by ambulance companies or first responders, the dispatchers or ambulance companies may be able to search and access the form of the individual that is in need of medical attention or the individual's form that is calling 911. The forms may be searched by different options. They may be able to search for forms by name, address, date of birth, and or license plate number. The dispatchers and ambulance companies may be able to forward the forms to the first responders. They may have the ability to forward the forms to the first responders before they arrive on scene. They may have the ability to write (or type) and send additional information to the first responders, such as address (GPS or location marker), description of emergency, and incident number. The search may be modified such that it is easy to search forms by using radius, zip code. Further, the individuals and groups have ability to forward form to their local dispatch and ambulance company, fire department and or any agency. The individuals may have the option of making their form available to the agencies they choose. The website may be integrated with 911 dispatch. Further, a responder software application may work in parallel with dispatch or ambulance agency profile and the website. Moreover, hospitals may create profile to have access to forms and may receive forms. The hospitals may have their own login and page. They may be able to search and access forms. The individuals may have the ability and option to forward forms to certain hospitals only making it available to those hospitals.

According to some aspects, a software application for first responders (responder application) is disclosed. Only the first responders or healthcare providers may be allowed to download this version of the application. Once verified as a first responder, health care provider may be able to download and log into the application (or website). The responder application has the same search capabilities of dispatch and ambulance agencies. The responder application may search patient form while on scene, in the event form could not be forwarded or accessed before they arrived on scene. The responder application may be able to access form and information contained in form. The responder application may have option to use GPS to find the location of incident. The responder application may call or text emergency contacts. The responder application may forward form to other responders. The responder application may forward form to a receiving hospital. The receiving hospital may have ETA of arrival of patient (GPS) from the responders' current location and form of the individual (patient). The responder has ability to take photograph from within the responder application of the incident or injury to forward to hospital. The responder application may forward one or both of form and photograph. Doctors or medical control may able to communicate with the first responders through the responder application, showing which doctor is available to take calls. The doctors or medical control may be available to take calls and communicate with the first responders on the scene, if and when needed. The doctors and medical control may be able to see the scene through the camera of the responders' phone through the responder application.

According to some aspects, the present disclosure may include several steps on the user side, the specific steps varying according to types of users. The users may be divided into two primary subgroups, the first subgroup being civilian entities and the second subgroup being first responders. Examples of civilian entities include individuals, nursing homes, assisted living, senior living, schools, business, employers, and universities.

The first step is the creation of an account and submission of forms. Depending on the user type, this process may vary. Specifically, the civilian entities may fill out personal and medical profiles, including submitting pertinent forms as needed. The individuals have the ability to create profiles for themselves or others. For example, a person may create profiles for family members (such as parents and grandparents). Similarly, healthcare entities (such as nursing homes) may have employees fill out forms for residents of the facility. The forms may be uploaded by the healthcare entity may be stored for future expedited reference, by providing a corresponding page (or button) that the healthcare entity may access to view resident profiles. Other entities (such as schools, and companies) may have the ability to view forms of students, employees, or related individuals by clicking a corresponding button or viewing their own page, provided the individual grants the entity permission to access their personal forms.

Once an individual creates a profile and submits forms detailing personal and medical information, they may update it through the software application at any time. The updates may also be made through a corresponding website. The created profile and corresponding forms may then be forwarded to other civilian entities (such as nursing homes and schools).

Further, the first responders may create a profile that provides them with access to forms (emergency medical forms) and the ability to forward forms to other entities. The emergency personnel (including dispatchers, and ambulance companies), may create a profile in order to gain access to medical forms and personal information regarding individuals. Once the emergency personnel have been verified, they are provided an interface that allows them to search a database for personal forms. The searches may be filtered according to name, address, date of birth, and license plate number. The searches may be performed by the dispatchers or ambulance companies and the results may be forwarded to the first responders before the latter arrive on scene. Additional information may be provided for the first responders by the dispatchers or ambulance companies, including an address of emergency (such as GPS and location marker), description of emergency, incident #, and times. Further, filters may be applied to the search, examples of which include a radius of interest and a zip code. Further, the emergency personnel may receive forms directly from individuals in an emergency situation, negating the need for a search and facilitating a faster response. The software application, as provided for first responders, works in parallel with the websites and profiles of dispatch and ambulance companies. Further, hospitals and similar institutions may be provided with their own icon or page. They may search and access forms in a similar manner as other emergency personnel, as described above. The individuals may forward pertinent medical information to hospitals.

Moreover, the first responders and the medical personal may be provided with a separate interface that requires verification. In addition to allowing the dispatch and ambulance companies to search for patient information, the first responders may perform a search at the scene if such information was not accessed prior to arrival. The first responders may then search for and access pertinent medical information when responding to an emergency. Further, the first responders may ping their location to better coordinate with other emergency response personnel. The hospitals may also be updated regarding the status of an emergency situation, including receiving forms for incoming patients, along with #, ETA of arrival (calculated through GPS). The first responders may also capture and transmit photographs to hospitals. When a form is searched and viewed, it may show the first responders name (and agency) who viewed the form on the individual's profile.

According to some aspect, the present disclosure provides a website, a system, one or more software applications. The present disclosure provides one or more advantages including providing better preparation in the event of a medical emergency. Further, the medical information is in the hands of paramedics before they arrive on a medical emergency scene. Yet further, the first responders may access forms while on scene in the event could not be accessed before arrival. Further, when there's a medical emergency, paramedics and EMT's ask certain questions while on scene, with the present disclosure those questions will be answered in advance. Moreover, there is no more hassle of searching for a medication card, list or other paper form. Further, the present disclosure allows individual to send their form to dispatchers or ambulance companies, allowing dispatch or ambulance companies to have your form already on file in the event of a medical emergency. Further, the present disclosure allows individuals to send their form to hospitals, allowing hospitals to have the form already on file in the event of a medical emergency. Further, the first responders will be able to forward form before or en route to a receiving hospital. The present disclosure provides 24/7 access to the medical information. Individuals may update and edit their information anytime. The present disclosure provides may send reminders through email, phone or mail. Further, the present disclosure allows searching by license plate number. Moreover, the medical information is only accessible to granted users, such as dispatchers, ambulance agencies, first responders, and hospitals.

Both the foregoing summary and the following detailed description provide examples and are explanatory only. Accordingly, the foregoing summary and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE DRAWINGS

The accompanying drawings, which are incorporated in and constitute a part of this disclosure, illustrate various embodiments of the present disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the applicants. The applicants retain and reserve all rights in their trademarks and copyrights included herein, and grant permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure.

FIG. 1 illustrates an exemplary environment in which embodiments of the present disclosure may be implemented.

FIG. 2 illustrates a block diagram of a system for facilitating provisioning of health data during emergencies in accordance with some embodiments.

FIG. 3 illustrates a user interface of a smartphone application in accordance with some embodiments.

FIG. 4 illustrates a user interface of the smartphone application in accordance with some embodiments.

FIG. 5 illustrates a user interface of the smartphone application in accordance with some embodiments.

FIG. 6 illustrates a user interface of the smartphone application in accordance with some embodiments.

FIG. 7 illustrates a flowchart of a method for facilitating provisioning of health data during emergencies in accordance with some embodiments.

FIG. 8 illustrates a flowchart of the method for verifying professional devices in accordance with some embodiments.

FIG. 9 illustrates a flowchart of the method for searching health data in accordance with some embodiments.

FIG. 10 illustrates a flowchart of the method for identifying a user in accordance with some embodiments.

FIG. 11 illustrates a flowchart of the method for identifying an individual based on biometric information in accordance with some embodiments.

FIG. 12 illustrates a flowchart of the method for identifying mobile emergency responders in accordance with some embodiments.

FIG. 13 illustrates an exemplary computing system that may be employed to implement processing functionality for various embodiments.

### DETAIL DESCRIPTIONS OF THE INVENTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim a limitation found herein that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present invention. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims. The present disclosure contains headers. It should be understood that these headers are used as references and are not to be construed as limiting upon the subjected matter disclosed under the header.

The present disclosure includes many aspects and features. Moreover, while many aspects and features relate to, and are described in, the context of provisioning health data, embodiments of the present disclosure are not limited to use only in this context.

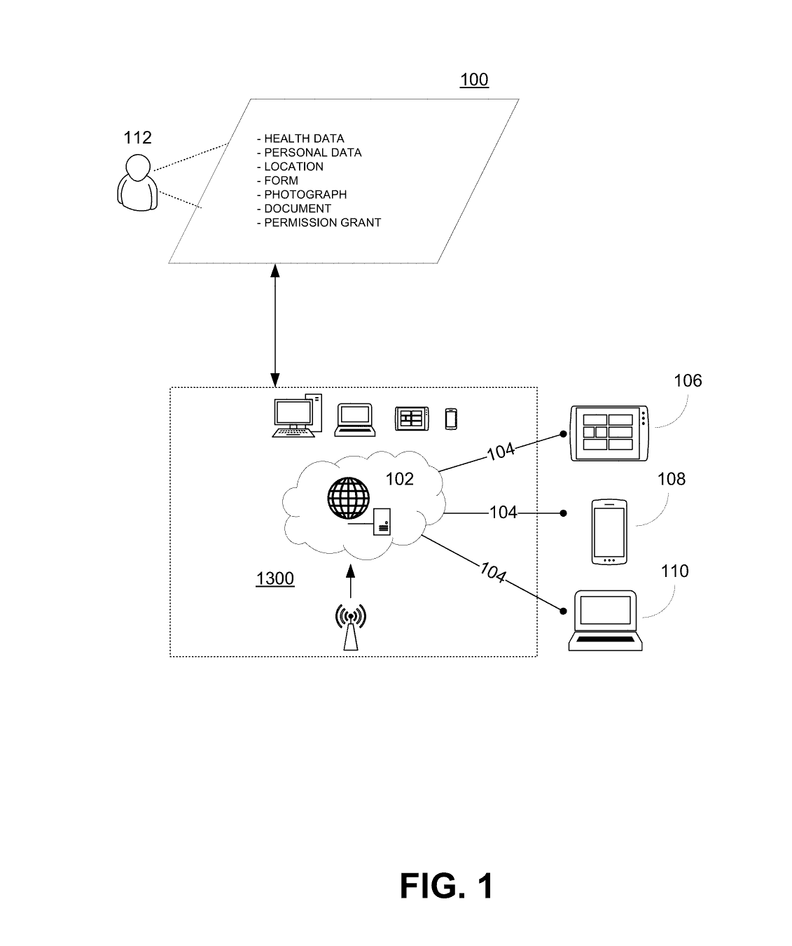

FIG. 1 is an illustration of a platform consistent with various embodiments of the present disclosure. By way of non-limiting example, the online platform 100 for facilitating provisioning of health data during emergencies may be hosted on a centralized server 102, such as, for example, a cloud computing service. The centralized server 102 may communicate with other network entities, such as, for example, a mobile device (such as a smartphone, a laptop, a tablet computer etc.) and other electronic devices (such as desktop computers, etc.) over a communication network 104, such as, but not limited to, the Internet. Further, users of the platform may include one or more relevant parties such as, individuals, first responders and professionals. The individuals may include patients, family members of patients and employees at nursing homes, senior living communities, and care facilities. The first responders may be paramedics in an ambulance. The professionals may include emergency professionals, paramedics, fire fighters, physicians, clinicians, surgeons, nurses and social workers who may assist the patient during a medical emergency. Accordingly, electronic devices operated by the one or more relevant parties may be in communication with the platform. For example, the platform 100 may be in communication with an individual electronic device 106 operated by the individual, a first responder electronic device 108 operated by the first responder and a professional electronic device 110 operated by the professional. A user 112, such as the one or more relevant parties, may access platform 100 through a software application. The software application may be embodied as, for example, but not be limited to, a website, a web application, a desktop application, and a mobile application compatible with a computing device 1300. Accordingly, in an instance, the user 112 may be a first responder who may search and retrieve health data for an individual facing a medical emergency.

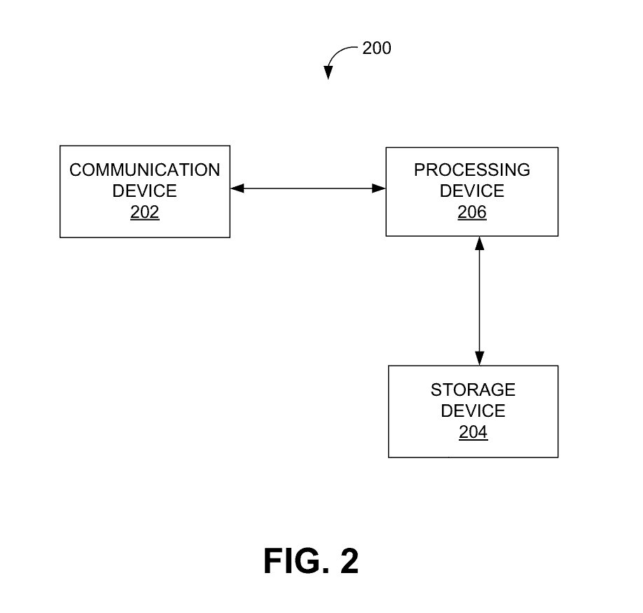

Turning to FIG. 2, a system 200 for facilitating provisioning of health data during emergencies, in accordance with some embodiments. The system 200 includes a communication device 202, a storage device 204 and a processing device 206.

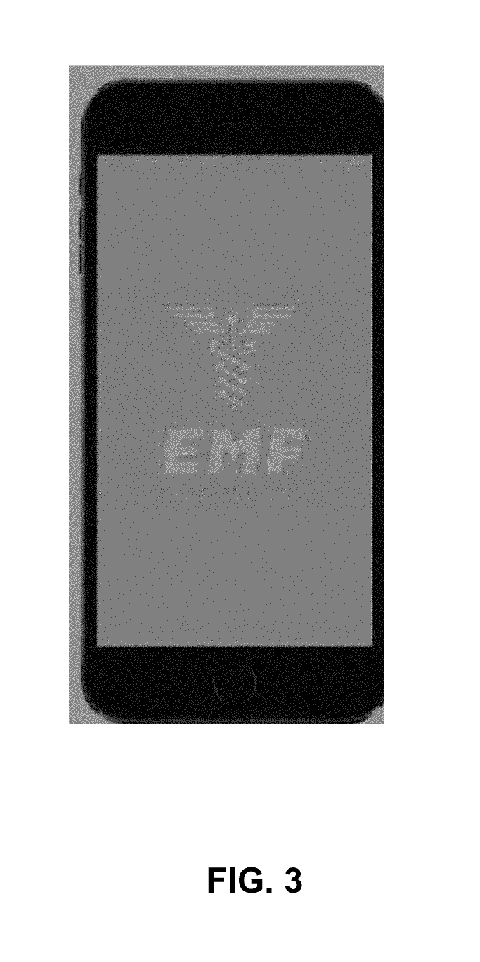

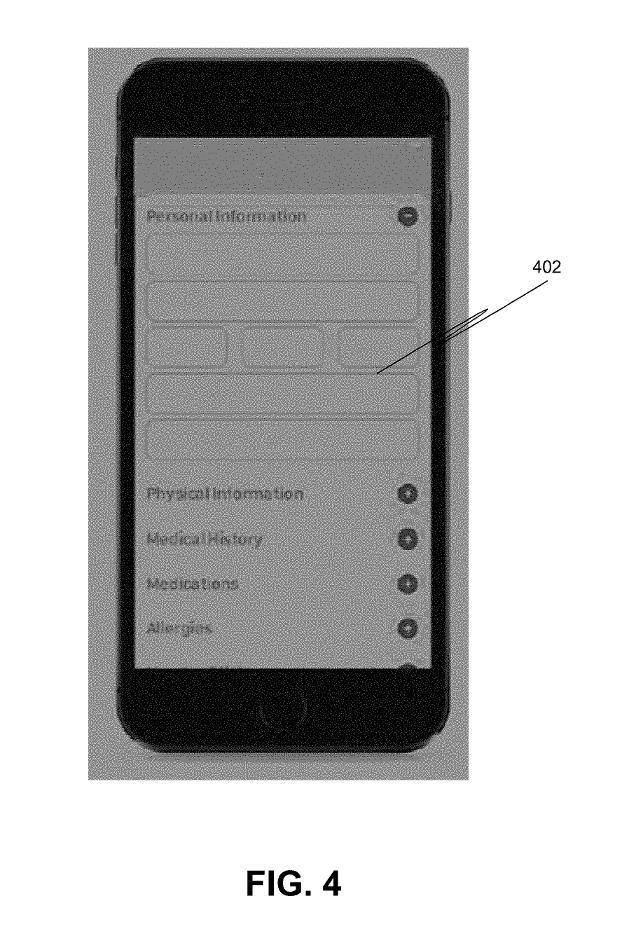

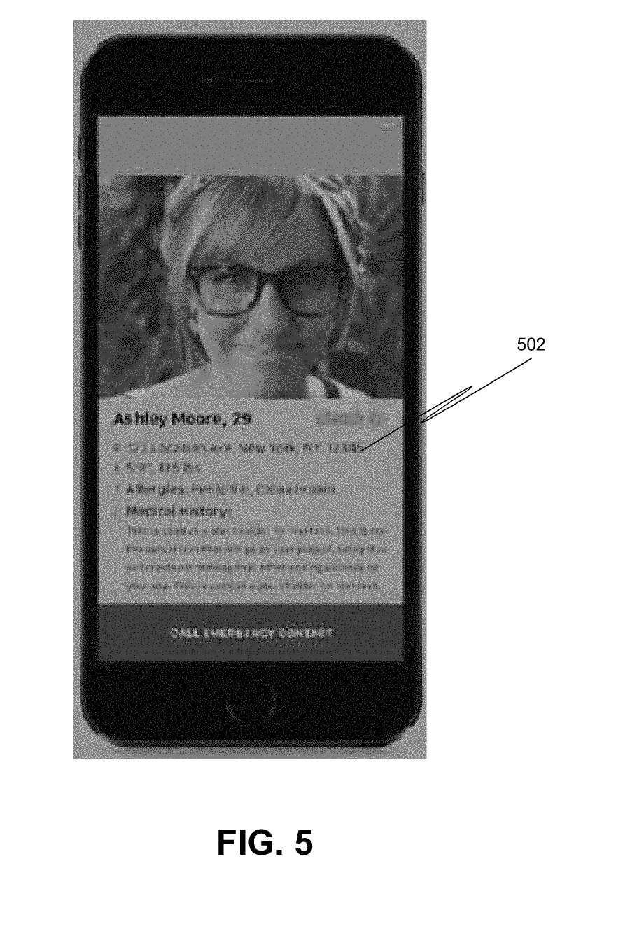

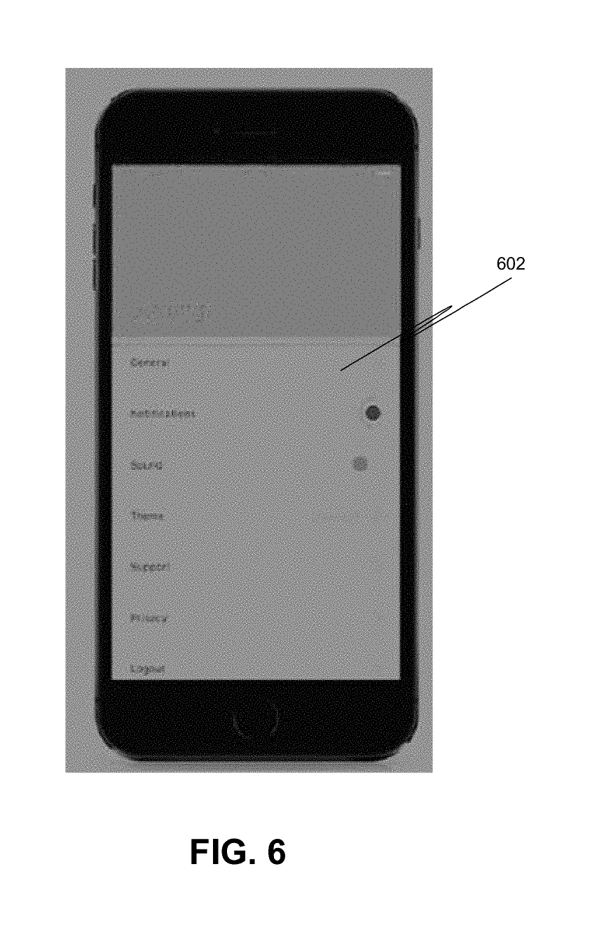

The communication device 202 may be configured for receiving health data associated with an individual from an individual device. The individual device may be an electronic device such as, but not limited to, a laptop computer, a tablet computer, a desktop computer, and a smartphone. Accordingly, a person such as the individual or another human acting on behalf of the individual may enter the health data into the individual device. The health data may be received at multiple time instants. The health data may include one or both of historical health data (medical history) and a current health data (current vitals). For example, the user may use a software application “Emergency Medical Form (EMF)” installed on their smartphone as shown in FIG. 3. The EMF application may provide a user interface 402 including a form as shown in FIG. 4. The user may enter personal and health data into the form on the user interface 402. Thereafter, a user profile 502 may be created as shown in FIG. 5. Further, the EMF application may provide a user interface 602 that allows the user to edit settings of the software application as shown in FIG. 6.

Further, the communication device 202 may be configured for receiving an indication of a medical emergency associated with the individual. Yet further, the communication device 202 may be configured for receiving a location of the individual from a mobile device. The mobile device may be configured to detect the location. The current location of the user may be used to automatically identify the relevant medical professional with whom the health data of the individual may be shared. Accordingly, when the individual suffers an emergency, one or more nearest medical facilities may be identified.

Moreover, the communication device 202 may be configured for transmitting the health data to one or more professional devices. In some embodiments, the health data may be transmitted to the one or more professional devices of medical professionals at one or more identified medical facilities. In alternate embodiments, based on the location, a nearby or approaching ambulance may also be identified and the health data may be transmitted to the paramedics in the ambulance.

The storage device 204 may be configured for storing the health data in association with an identifier associated with the individual. The identifier may be one or more of a name, address, vehicle plate number, social security number.

Further, the storage device 204 may be configured for retrieving the health data associated with the individual based on receipt of the indication of the medical emergency.

The processing device 206 may be configured for identifying the one or more professional devices based on the location.

In some embodiments, the individual device may be configured to detect heath data of the individual. Accordingly, the health data may be automatically determined using medical devices, such as, fit band, glucose monitors, and blood pressure monitors. Such devices may be configured to automatically detect one or more clinical parameters of the individual may be equipped with a communication interface to facilitate uploading of the detected clinical parameter to a central server. These devices may be personal medical devices such as those used at home and professional medical devices such as those used in hospitals.

In some embodiments, the communication device 202 may be further configured for receiving one or more permission grants from the individual device. The one or more permission grants may indicate a permission for the one or more professional devices to access the health data of the individual. A permission grant may indicate a type of professional that may access the health data (such as emergency professionals, paramedics, fire fighters, clinicians, and surgeons). Further, the permission grant may indicate specific one or both of medical facilities and medical professionals. The medical professionals may be specified by their names. Yet further, the permission grant may indicate an extent of the health data that may be shared with medical professionals and under what circumstances.

In some embodiments, the communication device 202 may be further configured for receiving verification information from the one or more professional devices. Further, the processing device 206 may be further configured for analyzing the verification information in order to determine that the one or more professional devices are associated with one or more verified medical professionals. Accordingly, the transmitting of the health data may be based on the analyzing.

In some embodiments, the communication device 202 may be further configured for receiving one or more search criteria from the one or more professional devices. Further, the communication device 202 may be configured for transmitting one or more health data to the one or more professional devices. The one or more health data may include the health data of the user. Further, the storage device 204 may be further configured for searching the one or more health data associated with one or more individuals based on the search criteria. The search criteria may include one or more of a name, an address, a date of birth, a social security number and a license plate number associated with the one or more individuals. For example, health data of a user involved in an accident may be retrieved based solely on the license plate number. The license plate number may be available to the one or more professional devices from an accident report or a 911 call.

In some embodiments, the communication device 202 may be further configured for receiving an emergency phone call, wherein the indication of medical emergency is based on the emergency phone call. Accordingly, the processing device 206 may be further configured for analyzing the emergency phone call and detecting the identifier (associated with the individual) based on the analyzing. The retrieving of the health data may be based further on the detected identifier. Therefore, the identity of the individual may be established automatically based on speech analysis of an emergency phone call. Accordingly, for example, when one of a 911 call is reported and a call for an ambulance is received, the speech of the caller may be analyzed to determine a vehicle license plate number and any other identifying information. Based on the identity obtained in this manner, the storage device 204 may be queried to retrieve the health data of the person associated with the identifying information. Thus, in some embodiments, the burden of searching for relevant health data may be removed from the medical professionals.

In some embodiments, the communication device 202 may be further configured for receiving one or more biometric information of the individual from the mobile device. The processing device 206 may be further configured for analyzing the one or more biometric information and determining the identifier of the individual based on the one or more biometric information. The retrieving of the health data may be based further on the identifier. Accordingly, a paramedic may capture a biometric information of the individual in distress, such as a fingerprint or an iris scan, and then automatically retrieve the health data of the user based on the biometric information. This may be advantageous in cases where the individual is not in a condition to provide any identifying information or any identifying information (such as an ID card) of the individual is missing.

In some embodiments, the communication device 202 may be further configured for receiving multiple locations of to multiple professional devices. Each of the multiple professional devices may be configured to detect a corresponding location. Further, the communication device 202 may be configured for transmitting the indication of the medical emergency to the one or more professional devices. Accordingly, the processing device 206 may be configured for comparing the location of the individual with the multiple locations and identifying the one or more professional devices based on the comparing. Therefore, mobile emergency responders may be identified for attending to a medical emergency based on their relative location with respect to the individual. For example, a dispatcher may identify an ambulance to attend to the medical emergency based on the location of the ambulance being in the vicinity of the location of the individual. Accordingly, the heath data may be transmitted to the ambulance thus identified along with the request to attend to the medical emergency.

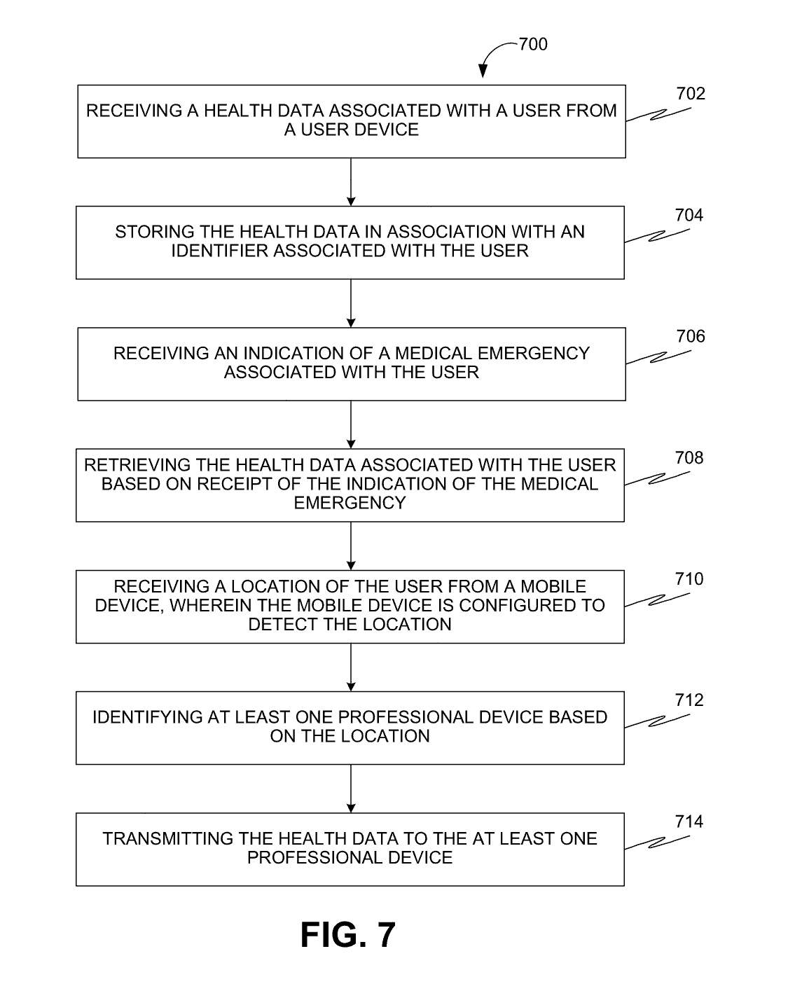

FIG. 7 illustrates a flowchart of a method 700 for facilitating provisioning of health data during emergencies in accordance with some embodiments.

At 702, the method 700 includes receiving, using a communication device (such as the communication device 202), a health data associated with an individual from an individual device. The individual device may be an electronic device such as, but not limited to, a laptop computer, a tablet computer, a desktop computer, and a smartphone. Further, the individual device may be configured to detect heath data of the user. The health data may be received at multiple time instants, wherein the health data may include historical health data and a current health data

At 704, the method 700 includes storing, using a storage device (such as the storage device 204), the health data in association with an identifier associated with the individual.

At 706, the method 700 includes receiving, using the communication device, an indication of a medical emergency associated with the individual.

At 708, the method 700 includes retrieving, using the storage device, the health data associated with the individual based on receipt of the indication of the medical emergency.

At 710, the method 700 includes receiving, using the communication device, a location of the individual from a mobile device. The mobile device may be configured to detect the location.

At 712, the method 700 includes identifying, using the processing device (such as the processing device 206), one or more professional devices based on the location.

At 714, the method 700 includes transmitting, using the communication device, the health data to the one or more professional devices.

In further embodiments, the method 700 may include receiving, using the communication device, one or more permission grants from the individual device. The one or more permission grants may indicate a permission for the one or more professional devices to access the health data of the individual.

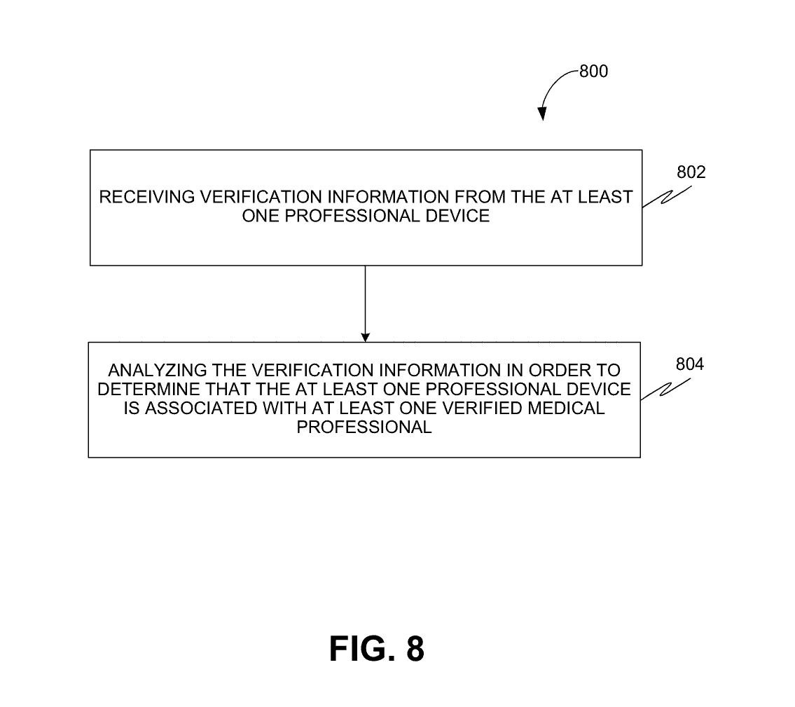

In further embodiments, the method 700 may include additional steps of a method 800 shown in FIG. 8. FIG. 8 illustrates a flowchart of the method 800 for verifying professional devices in accordance with some embodiments. At 802, the method includes receiving, using the communication device, verification information from the one or more professional devices. At 804, the method includes analyzing, using the processing device, the verification information in order to determine that the one or more professional devices are associated with one or more verified medical professionals. Accordingly, the transmitting of the health (at 714) data may be based on the analyzing.

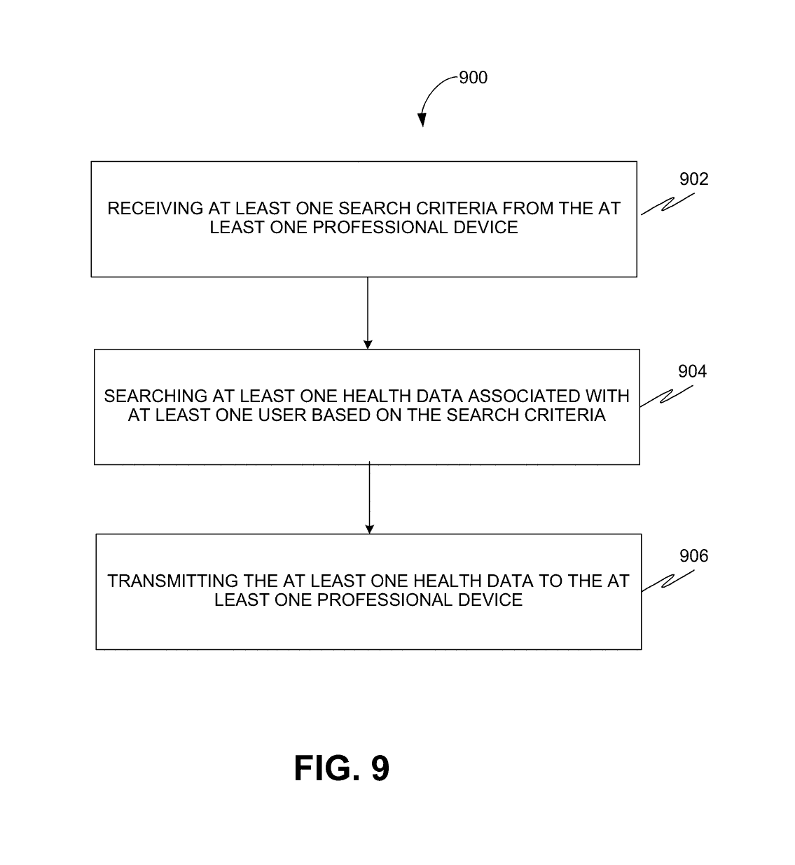

In further embodiments, the method 700 may include additional steps of a method 900 shown in FIG. 9. FIG. 9 illustrates a flowchart of the method 900 for searching health data in accordance with some embodiments. At 902, the method 900 includes receiving, using the communication device, one or more search criteria from the one or more professional devices. The search criteria may include one or more of a name, an address, a date of birth, a social security number and a license plate number associated with one or more users.

At 904, the method 900 includes searching, using the storage device, one or more health data associated with the one or more individuals based on the search criteria.

At 906, the method 900 includes transmitting, using the communication device, the one or more health data to the one or more professional devices. The one or more health data may include the health data of the individual.

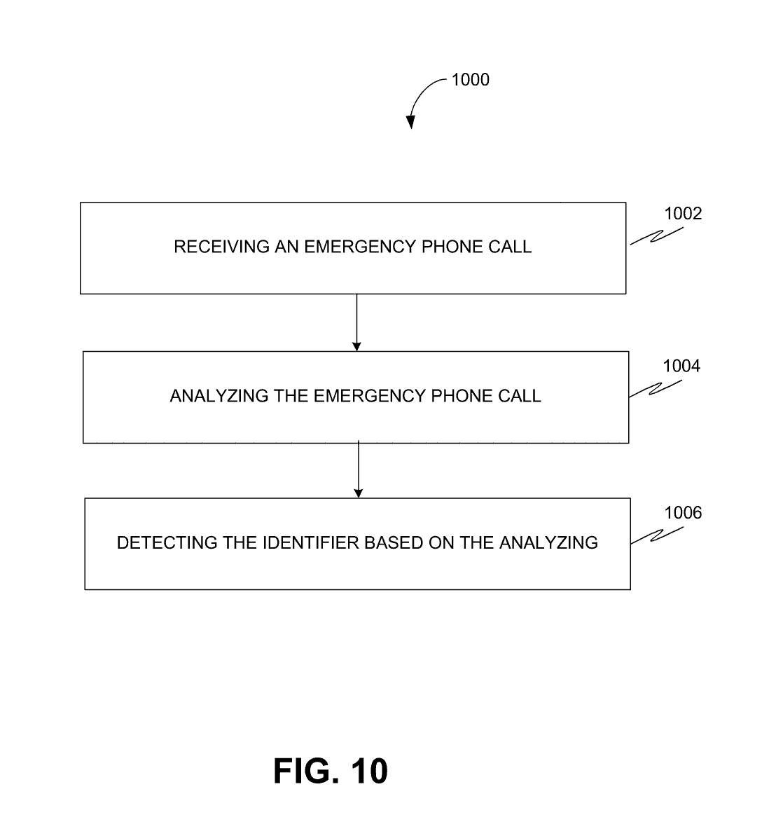

In further embodiments, the method 700 may include additional steps of a method 1000 shown in FIG. 10. FIG. 10 illustrates a flowchart of the method 1000 for identifying an individual in accordance with some embodiments. At 1002, the method 1000 includes receiving, using the communication device, an emergency phone call. The indication of medical emergency may be based on the emergency phone call.

At 1004, the method 1000 includes analyzing, using the processing device, the emergency phone call.

At 1006, the method 1000 includes detecting, using the processing device, the identifier based on the analyzing. The retrieving (at 708) of the health data is based further on the identifier.

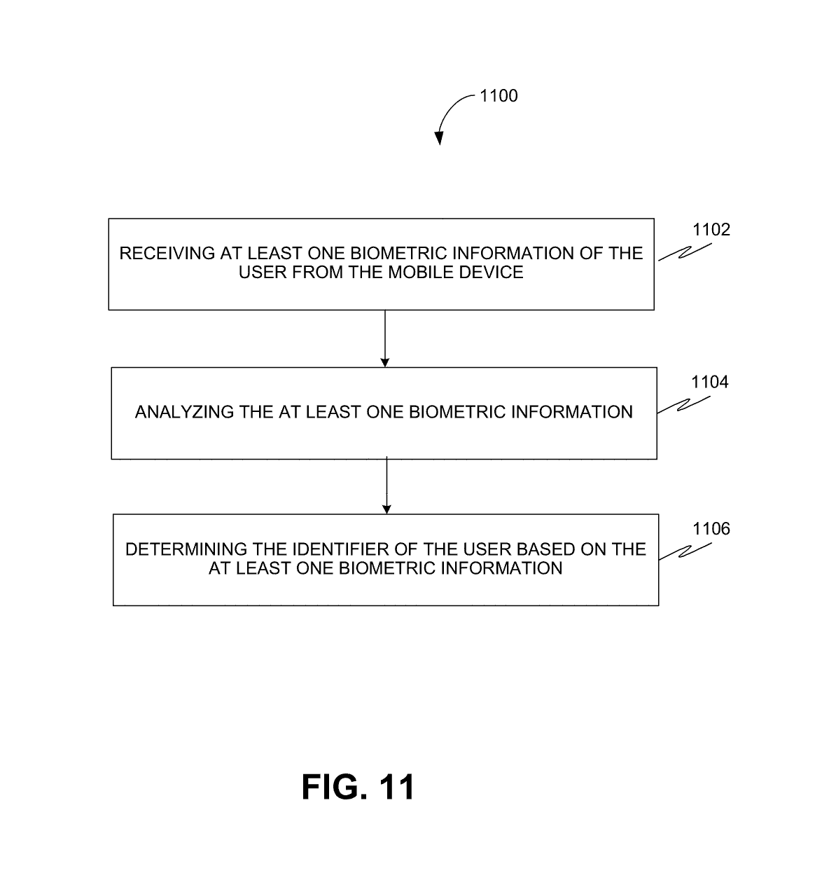

In further embodiments, the method 700 may include additional steps of a method 1100 shown in FIG. 11. FIG. 11 illustrates a flowchart of the method for identifying an individual based on biometric information in accordance with some embodiments. At 1102, the method 1100 includes receiving, using the communication device, one or more biometric information of the individual from the mobile device.

At 1104, the method 1100 includes analyzing, using the processing device, the one or more biometric information.

At 1106, the method 1100 includes determining, using the processing device, the identifier of the individual based on the one or more biometric information. The retrieving (at 708) of the health data is based further on the identifier.

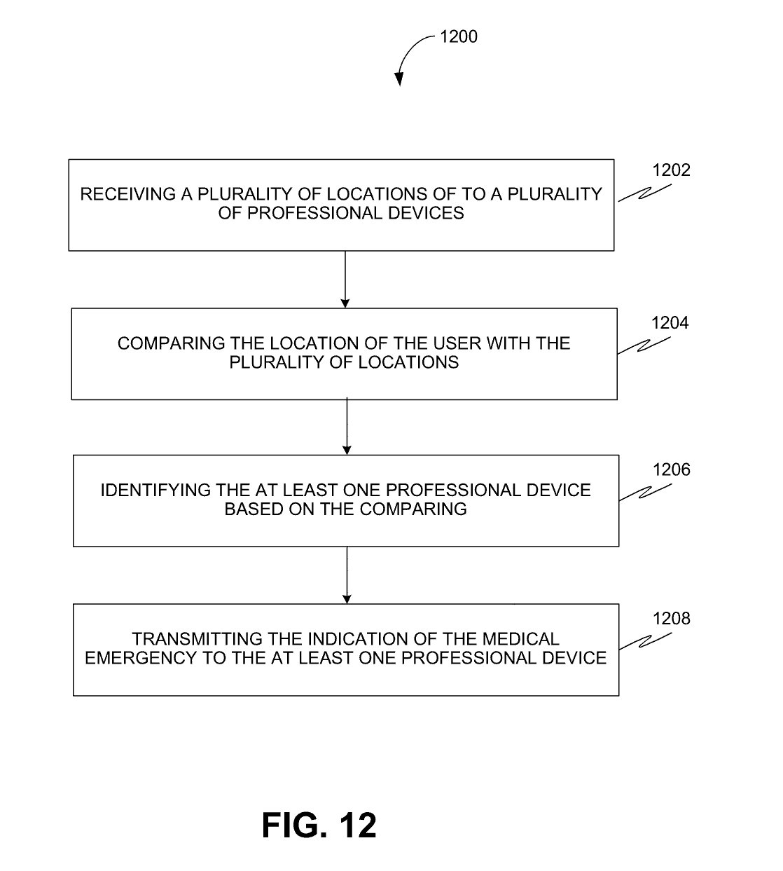

In further embodiments, the method 700 may include additional steps of a method 1200 shown in FIG. 12. FIG. 12 illustrates a flowchart of the method 1200 for identifying mobile emergency responders in accordance with some embodiments. At 1202, the method 1200 includes receiving, using the communication device, multiple locations of to multiple professional devices. Each of the multiple professional devices may be configured to detect a corresponding location.

At 1204, the method 1200 includes comparing, using the processing device, the location of the individual with the multiple locations.

At 1206, the method 1200 includes identifying, using the processing device, the one or more professional devices based on the comparing.

At 1208, the method 1200 includes transmitting, using the communication device, the indication of the medical emergency to the one or more professional devices.

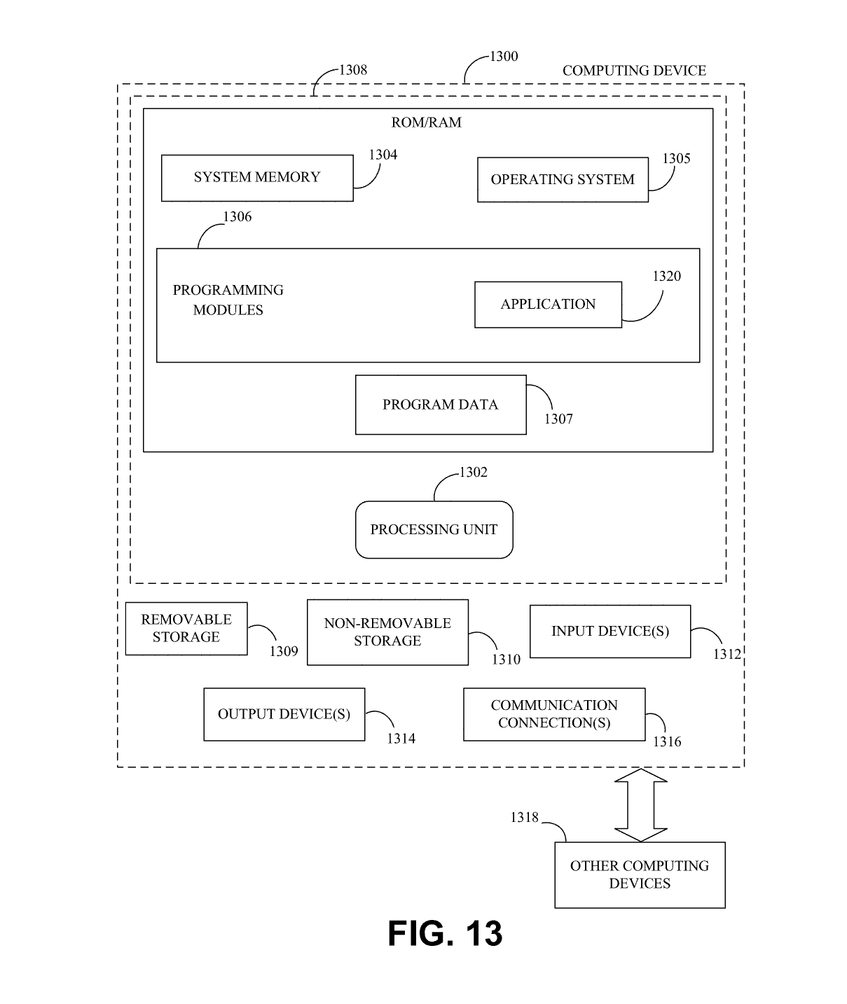

FIG. 13 is a block diagram of a system including computing device 1300. Consistent with an embodiment of the disclosure, the aforementioned memory storage and processing unit may be implemented in a computing device, such as computing device 1300 of FIG. 13. Any suitable combination of hardware, software, or firmware may be used to implement the memory storage and processing unit. For example, the memory storage and processing unit may be implemented with computing device 1300 or any of other computing devices 1318, in combination with computing device 1300. The aforementioned system, device, and processors are examples and other systems, devices, and processors may comprise the aforementioned memory storage and processing unit, consistent with embodiments of the disclosure.

With reference to FIG. 13, a system consistent with an embodiment of the disclosure may include a computing device or cloud service, such as computing device 1300. In a basic configuration, computing device 1300 may include at least one processing unit 1302 and a system memory 1304. Depending on the configuration and type of computing device, system memory 1304 may comprise, but is not limited to, volatile (e.g. random access memory (RAM)), non-volatile (e.g. read-only memory (ROM)), flash memory, or any combination. System memory 1304 may include operating system 1305, one or more programming modules 1306, and may include a program data 1307. Operating system 1305, for example, may be suitable for controlling computing device 1300's operation. In one embodiment, programming modules 1306 may include image encoding module, machine learning module and image classifying module. Furthermore, embodiments of the disclosure may be practiced in conjunction with a graphics library, other operating systems, or any other application program and is not limited to any particular application or system. This basic configuration is illustrated in FIG. 13 by those components within a dashed line 1308.

Computing device 1300 may have additional features or functionality. For example, computing device 1300 may also include additional data storage devices (removable and/or non-removable) such as, for example, magnetic disks, optical disks, or tape. Such additional storage is illustrated in FIG. 13 by a removable storage 1309 and a non-removable storage 1310. Computer storage media may include volatile and nonvolatile, removable and non-removable media implemented in any method or technology for storage of information, such as computer-readable instructions, data structures, program modules, or other data. System memory 1304, removable storage 1309, and non-removable storage 1310 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 1300. Any such computer storage media may be part of device 1300. Computing device 1300 may also have input device(s) 1312 such as a keyboard, a mouse, a pen, a sound input device, a touch input device, etc. Output device(s) 1314 such as a display, speakers, a printer, etc. may also be included. The aforementioned devices are examples and others may be used.

Computing device 1300 may also contain a communication connection 1316 that may allow device 1300 to communicate with other computing devices 1318, such as over a network in a distributed computing environment, for example, an intranet or the Internet. Communication connection 1316 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both storage media and communication media.

As stated above, a number of program modules and data files may be stored in system memory 1304, including operating system 1305. While executing on processing unit 1302, programming modules 1306 (e.g., application 1320) may perform processes including, for example, one or more stages of methods 700, 800, 900, 1000, 1100 and 1200 as described above. The aforementioned process is an example, and processing unit 1302 may perform other processes. Other programming modules that may be used in accordance with embodiments of the present disclosure may include image encoding applications, machine learning application, image classifiers etc.

Generally, consistent with embodiments of the disclosure, program modules may include routines, programs, components, data structures, and other types of structures that may perform particular tasks or that may implement particular abstract data types. Moreover, embodiments of the disclosure may be practiced with other computer system configurations, including hand-held devices, multiprocessor systems, microprocessor-based or programmable consumer electronics, minicomputers, mainframe computers, and the like. Embodiments of the disclosure may also be practiced in distributed computing environments where tasks are performed by remote processing devices that are linked through a communications network. In a distributed computing environment, program modules may be located in both local and remote memory storage devices.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general purpose computer or in any other circuits or systems.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, solid state storage (e.g., USB drive), or a CD-ROM, a carrier wave from the Internet, or other forms of RAM or ROM. Further, the disclosed methods' stages may be modified in any manner, including by reordering stages and/or inserting or deleting stages, without departing from the disclosure.

### DETAIL DESCRIPTIONS OF THE EMBODIMENTS

A method of facilitating provisioning of health data during emergencies is provided. The method may include receiving, using a communication device, a health data associated with an individual from an individual device. Further, the method may include storing, using a storage device, the health data in association with an identifier associated with the individual. Further, the method may include receiving, using the communication device, an indication of a medical emergency associated with the individual. Further, the method may include retrieving, using the storage device, the health data associated with the individual based on receipt of the indication of the medical emergency. Further, the method may include receiving, using the communication device, a location of the individual from a mobile device. Further, the mobile device may be configured to detect the location. Further, the method may include identifying, using the processing device, at least one professional device based on the location. Further, the method may include transmitting, using the communication device, the health data to the at least one professional device.

In some embodiments, the individual device may be configured to detect heath data of the individual.

In some embodiments, the health data may be received at a plurality of time instants. Further, the health data may include historical health data and a current health data.

In some embodiments, the method may further include receiving, using the communication device, at least one permission grant from the individual device. Further, the at least one permission grant indicates a permission for the at least one professional device to access the health data of the individual.

In some embodiments, the method may further include receiving, using the communication device, verification information from the at least one professional device and analyzing, using the processing device, the verification information in order to determine that the at least one professional device may be associated with at least one verified medical professional. Further, the transmitting of the health data may be based on the analyzing.

In some embodiments, the method may further include receiving, using the communication device, at least one search criteria from the at least one professional device; searching, using the storage device, at least one health data associated with at least one individual based on the search criteria; and transmitting, using the communication device, the at least one health data to the at least one professional device. Further, the at least one health data may include the health data of the individual.

In some embodiments, the search criteria may include one or more of a name, an address, a date of birth, a social security number and a license plate number associated with the at least one individual.

In some embodiments, the method may further include receiving, using the communication device, an emergency phone call. Further, the indication of medical emergency may be based on the emergency phone call; analyzing, using the processing device, the emergency phone call; and detecting, using the processing device, the identifier based on the analyzing. Further, the retrieving of the health data may be based on the identifier.

In some embodiments, the method may further include receiving, using the communication device, at least one biometric information of the individual from the mobile device; analyzing, using the processing device, the at least one biometric information; determining, using the processing device, the identifier of the individual based on the at least one biometric information. Further, the retrieving of the health data may be based on the identifier.

In some embodiments, the method may further include receiving, using the communication device, a plurality of locations of to a plurality of professional devices. Further, each of the plurality of professional devices may be configured to detect a corresponding location; comparing, using the processing device, the location of the individual with the plurality of locations; identifying, using the processing device, the at least one professional device based on the comparing; and transmitting, using the communication device, the indication of the medical emergency to the at least one professional device.

A system for facilitating provisioning of health data during emergencies is also provided. The system may include a communication device configured for receiving a health data associated with an individual from an individual device. Further, the communication device may be configured for receiving an indication of a medical emergency associated with the individual. Further, the communication device may be configured for receiving a location of the individual from a mobile device. Further, the mobile device may be configured to detect the location. Further, the communication device may be configured for transmitting the health data to at least one professional device. Further, the system may include a storage device configured for storing the health data in association with an identifier associated with the individual. Further, the storage device may be configured for retrieving the health data associated with the individual based on receipt of the indication of the medical emergency. Further, the system may include a processing device configured for identifying the at least one professional device based on the location.

In some embodiments, the individual device may be configured to detect heath data of the individual.

In some embodiments, the health data may be received at a plurality of time instants. Further, the health data may include historical health data and a current health data.

In some embodiments, the communication device may be further configured for receiving at least one permission grant from the individual device. Further, the at least one permission grant indicates a permission for the at least one professional device to access the health data of the individual.

In some embodiments, the communication device may be further configured for receiving verification information from the at least one professional device. Further, the processing device may be configured for analyzing the verification information in order to determine that the at least one professional device may be associated with at least one verified medical professional. Further, the transmitting of the health data may be based on the analyzing.

In some embodiments, the communication device may be further configured for: receiving at least one search criteria from the at least one professional device; and transmitting at least one health data to the at least one professional device. Further, the at least one health data may include the health data of the individual. Further, the storage device may be configured for searching the at least one health data associated with at least one individual based on the search criteria.

In some embodiments, the search criteria may include one or more of a name, an address, a date of birth, a social security number and a license plate number associated with the at least one individual.

In some embodiments, the communication device may be further configured for receiving an emergency phone call. Further, the indication of medical emergency may be based on the emergency phone call. Further, the processing device may be configured for: analyzing the emergency phone call; and detecting the identifier based on the analyzing. Further, the retrieving of the health data may be based on the identifier.

In some embodiments, the communication device may be further configured for receiving at least one biometric information of the individual from the mobile device. Further, the processing device may be configured for analyzing the at least one biometric information; and determining the identifier of the individual based on the at least one biometric information. Further, the retrieving of the health data may be based on the identifier.

In some embodiments, the communication device may be further configured for: receiving a plurality of locations of to a plurality of professional devices. Further, each of the plurality of professional devices may be configured to detect a corresponding location; and transmitting the indication of the medical emergency to the at least one professional device. Further, the processing device may be configured for comparing, using the processing device, the location of the individual with the plurality of locations; and identifying the at least one professional device based on the comparing.

Although the invention has been explained in relation to its preferred embodiment, it is to be understood that many other possible modifications and variations can be made without departing from the spirit and scope of the invention.

I/We claim:

1. A method of facilitating provisioning of health data during emergencies, the method comprising:
receiving, using a communication device, a health data associated with an individual from an individual device;
storing, using a storage device, the health data in association with an identifier associated with the individual;
receiving, using the communication device, an indication of a medical emergency associated with the individual;
retrieving, using the storage device, the health data associated with the individual based on receipt of the indication of the medical emergency;
receiving, using the communication device, a location of the individual from a mobile device, wherein the mobile device is configured to detect the location;
identifying, using the processing device, at least one professional device based on the location; and
transmitting, using the communication device, the health data to the at least one professional device.

2. The method of claim 1, wherein the individual device is configured to detect heath data of the individual.

3. The method of claim 2, wherein the health data is received at a plurality of time instants, wherein the health data comprises historical health data and a current health data.

4. The method of claim 1 further comprising receiving, using the communication device, at least one permission grant from the individual device, wherein the at least one permission grant indicates a permission for the at least one professional device to access the health data of the individual.

5. The method of claim 1 further comprising:
receiving, using the communication device, verification information from the at least one professional device; and
analyzing, using the processing device, the verification information in order to determine that the at least one professional device is associated with at least one verified medical professional, wherein the transmitting of the health data is based on the analyzing.

6. The method of claim 1 further comprising:
receiving, using the communication device, at least one search criteria from the at least one professional device;
searching, using the storage device, at least one health data associated with at least one individual based on the search criteria; and
transmitting, using the communication device, the at least one health data to the at least one professional device, wherein the at least one health data comprises the health data of the individual.

7. The method of claim 6, wherein the search criteria comprises at least one of a name, an address, a date of birth, a social security number and a license plate number associated with the at least one individual.

8. The method of claim 1 further comprising:
receiving, using the communication device, an emergency phone call, wherein the indication of medical emergency is based on the emergency phone call;
analyzing, using the processing device, the emergency phone call; and
detecting, using the processing device, the identifier based on the analyzing, wherein the retrieving of the health data is based further on the identifier.

9. The method of claim 1 further comprising:
receiving, using the communication device, at least one biometric information of the individual from the mobile device;
analyzing, using the processing device, the at least one biometric information; and
determining, using the processing device, the identifier of the individual based on the at least one biometric information, wherein the retrieving of the health data is based further on the identifier.

10. The method of claim 1 further comprising:
receiving, using the communication device, a plurality of locations of to a plurality of professional devices, wherein each of the plurality of professional devices is configured to detect a corresponding location;
comparing, using the processing device, the location of the individual with the plurality of locations;
identifying, using the processing device, the at least one professional device based on the comparing; and
transmitting, using the communication device, the indication of the medical emergency to the at least one professional device.

11. A system for facilitating provisioning of health data during emergencies, the system comprising:
a communication device configured for:
receiving a health data associated with an individual from an individual device;
receiving an indication of a medical emergency associated with the individual;
receiving a location of the individual from a mobile device, wherein the mobile device is configured to detect the location; and
transmitting the health data to at least one professional device;
a storage device configured for:
storing the health data in association with an identifier associated with the individual; and
retrieving the health data associated with the individual based on receipt of the indication of the medical emergency; and
a processing device configured for identifying the at least one professional device based on the location.

12. The system of claim 11, wherein the individual device is configured to detect heath data of the individual.

13. The system of claim 12, wherein the health data is received at a plurality of time instants, wherein the health data comprises historical health data and a current health data.

14. The system of claim 11, wherein the communication device is further configured for receiving at least one permission grant from the individual device, wherein the at least one permission grant indicates a permission for the at least one professional device to access the health data of the individual.

15. The system of claim 11, wherein the communication device is further configured for receiving verification information from the at least one professional device, wherein the processing device is further configured for analyzing the verification information in order to determine that the at least one professional device is associated with at least one verified medical professional, wherein the transmitting of the health data is based on the analyzing.

16. The system of claim 11, wherein the communication device is further configured for:
receiving at least one search criteria from the at least one professional device; and
transmitting at least one health data to the at least one professional device, wherein the at least one health data comprises the health data of the individual, wherein the storage device is further configured for searching the at least one health data associated with at least one individual based on the search criteria.

17. The system of claim 16, wherein the search criteria comprises at least one of a name, an address, a date of birth, a social security number and a license plate number associated with the at least one individual.

18. The system of claim 11, wherein the communication device is further configured for receiving an emergency phone call, wherein the indication of medical emergency is based on the emergency phone call, wherein the processing device is further configured for:
analyzing the emergency phone call; and
detecting the identifier based on the analyzing, wherein the retrieving of the health data is based further on the identifier.

19. The system of claim 11, wherein the communication device is further configured for receiving at least one biometric information of the individual from the mobile device, wherein the processing device is further configured for:
analyzing the at least one biometric information; and
determining the identifier of the individual based on the at least one biometric information, wherein the retrieving of the health data is based further on the identifier.

20. The system of claim 11, wherein the communication device is further configured for:
receiving a plurality of locations of to a plurality of professional devices, wherein each of the plurality of professional devices is configured to detect a corresponding location; and
transmitting the indication of the medical emergency to the at least one professional device, wherein the processing device is configured for:
comparing, using the processing device, the location of the individual with the plurality of locations; and
identifying the at least one professional device based on the comparing.
